(19) United States
(12) Patent Application Publication
(10) Pub. No.: US 2009/0276412 A1
(43) Pub. Date: Nov. 5, 2009

(54) Method, apparatus, and computer program product for providing usage analysis

(75) Inventors: Marko Anderson, Helsinki (FI); Manuel Lima, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/111,998

(22) Filed: Apr. 30, 2008

(51) Int. Cl. G06F 7/08; G06F 15/16; G06F 7/10; G06F 17/30

(52) U.S. Cl. 707/5; 707/7; 709/201; 707/E17.014

(57) ABSTRACT

An apparatus for providing usage analysis may include a processor. The processor may be configured to receive a plurality of usage attributes from a plurality of platforms, where the plurality of platforms may be associated with a user. In this regard, the plurality of usage attributes may have associations with a plurality of objects, and each usage attribute within the plurality of usage attributes may be indicative of an action taken by the user with respect to one object within the plurality of objects. The processor may be further configured to arrange indications of the objects within the plurality of objects based on the plurality of usage attributes for presentation. Associated methods and computer program products may also be provided.

### TECHNICAL FIELD

Embodiments of the present invention relate generally to analyzing usage of a device and, more particularly, relate to an apparatus, method and a computer program product for providing usage analysis of objects implemented by an electronic device.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. However, as the ease of information transfer increases, users continue to demand more and different types of data. Mobile devices, networks, personal computers, and other computing devices can now capture numerous types of information about users and their activities. Such information may include location information, phone call information (e.g., what contacts were called, duration of calls, what calls were received), status information (e.g., working, sleeping, watching a movie), media information (e.g., recent photographs taken, music played), etc. The availability of this information is desirable to users, not only with respect to information about themselves and their own activities, but also with respect to their friends and business contacts.

Currently, these and other types of information are being captured by various computing devices, but the information often goes unused since no common outlet for the information is available to users. Further, due to the lack of a common outlet for the information, the information cannot be shared with other users on a network. As such, users cannot consider, utilize or interact with the information to, for example, make decisions regarding activities performed by the users.

As such, it would be desirable to provide mechanisms for aggregating user information that is captured by various computing devices associated with the user. Moreover, it would be desirable to provide the information in a usable form for consideration and interaction by a user. In this same regard, it would be desirable to provide the ability to share a user's captured information with other users and allow the other users to interact with the information.

### BRIEF SUMMARY

A method, apparatus and computer program product are therefore provided that may enable usage analysis. In this regard, exemplary embodiments of the present invention may receive a plurality of usage attributes. Usage attributes may be indicative of an action taken by a user with respect to an object, such as a contact, a media item, an application, or the like. As such, each usage attribute may be associated with an object. Further, the usage attributes may be received from a plurality of platforms. Exemplary platforms may be mobile terminals, computers, network servers, or the like. In this regard, platforms may be associated with the user. Embodiments of the present invention may also arrange indications of objects for presentation, based on the received usage attributes.

In one exemplary embodiment, a method for usage analysis is provided. The method may include receiving a first plurality of usage attributes from a first plurality of platforms. In this regard, the first plurality of platforms may be associated with a first user. Further, each of the first plurality of usage attributes may be associated with, and indicative of, an action taken by the first user with respect to at least one of a first plurality of objects. The method may further include arranging indications of the first plurality of objects based on the first plurality of usage attributes for presentation.

In another exemplary embodiment, a computer program product for usage analysis is provided. The computer program product may include at least one computer-readable storage medium having computer-readable program code portions stored therein. The computer-readable program code portions may include a first executable portion, and a second executable portion. The first executable portion may be configured to receive a first plurality of usage attributes from a first plurality of platforms. In this regard, the first plurality of platforms may be associated with a first user, and each of the first plurality of usage attributes being associated with, and indicative of, an action taken by the first user with respect to at least one of a first plurality of objects. The second executable portion may be configured to arrange indications of the first plurality of objects based on the first plurality of usage attributes for presentation.

In another exemplary embodiment, an apparatus for usage analysis is provided. The apparatus may include a processor. The processor may be configured to receive a first plurality of usage attributes from a first plurality of platforms. In this regard, the first plurality of platforms may be associated with a first user, and each of the first plurality of usage attributes may be associated with, and indicative of, an action taken by the first user with respect to at least one of a first plurality of objects. The processor may be further configured to arrange indications of the first plurality of objects based on the first plurality of usage attributes for presentation.

In one exemplary embodiment, an apparatus for usage analysis is provided. The apparatus may include means for receiving a first plurality of usage attributes from a first plurality of platforms. In this regard, the first plurality of platforms may be associated with a first user. Further, each of the first plurality of usage attributes may be associated with, and indicative of, an action taken by the first user with respect to at least one of a first plurality of objects. The apparatus may further include means for arranging indications of the first plurality of objects based on the first plurality of usage attributes for presentation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram showing an apparatus with associated network connectivity for analyzing usage according to an exemplary embodiment of the present invention;

FIGS. 3a and 3b illustrate exemplary arrangements of indications of objects according to exemplary embodiments of the present invention;

FIG. 4 is a flowchart according to an exemplary method of analyzing usage according to an exemplary embodiment of the present invention;

FIG. 5 is a flowchart according to an exemplary method of analyzing usage according to an exemplary embodiment of the present invention;

FIG. 6 illustrates exemplary arrangement of indications of objects according to exemplary embodiments of the present invention; and

FIG. 7 illustrates an exemplary system of network entities according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

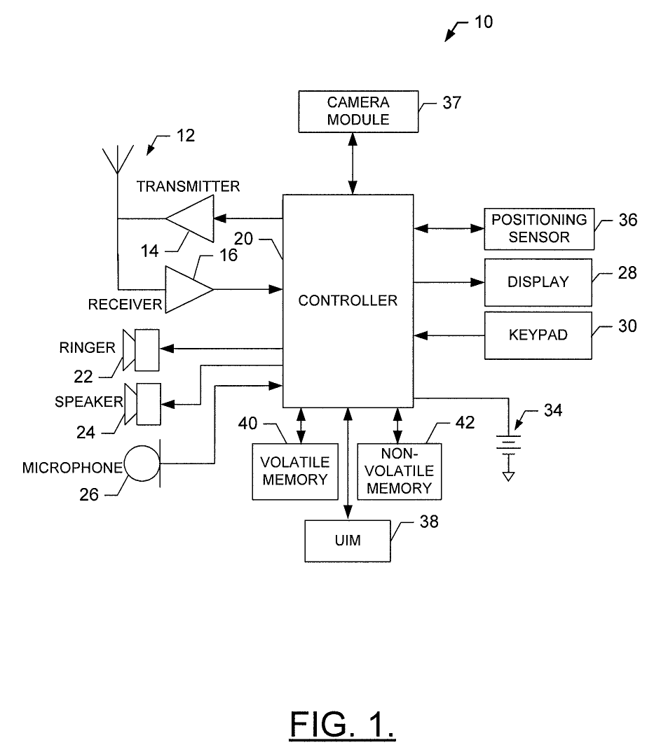

FIG. 1, one aspect of the invention, illustrates a block diagram of a mobile terminal 10 that would benefit from, and may be an exemplary apparatus of, embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 generation (3.9G) wireless communication protocols, such as Evolved Universal Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

The mobile terminal 10 may further include a positioning sensor 36 such as, for example, a global positioning system (GPS) module in communication with the controller 20. The positioning sensor 36 may be any means, device or circuitry for locating the position of mobile terminal 10. The positioning sensor 36 may include all hardware for locating the position of a mobile terminal 10. Alternatively or additionally, the positioning sensor 36 may utilize a memory device of the mobile terminal 10 to store instructions for execution by the controller 20 in the form of software necessary to determine the position of the mobile terminal 10. Although the positioning sensor 36 of this example may be a GPS module, the positioning sensor 36 may include or otherwise alternatively be embodied as, for example, an assisted global positioning system (Assisted-GPS) sensor, or a positioning client, which may be in communication with a network device to receive and/or transmit information, such as a sky or floor sensor, for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 36 includes a pedometer or inertial sensor. As such, the positioning sensor 36 may be capable of determining a location of the mobile terminal 10, with respect to, for example, longitudinal and latitudinal directions, and altitude direction of the mobile terminal 10, or a position relative to a reference point such as a destination or start point. Information from the positioning sensor 36 may then be communicated to a memory of the mobile terminal 10 or to another memory device to be stored as a position history or location information. Additionally, the positioning sensor 36 may be capable of utilizing the controller 20 to transmit/receive, via the transmitter 14/receiver 16, location information such as the position of the mobile terminal 10.

In some embodiments, the mobile terminal 10 includes a media capturing element, such as a camera, video and/or audio module, in communication with the controller 20. The media capturing element may be any means for capturing images, video and/or audio for storage, display or transmission. For example, in an exemplary embodiment in which the media capturing element is a camera module 37, the camera module 37 may include a selective capture mode where camera module 37 can form and save a digital image file from an image captured by camera module 37. In some embodiments, the camera module 37 can implement a preview mode where the current view from the camera module's optical hardware is displayed on, for example, display 28. In some embodiments, image data captured during preview mode is not saved for longevity, but rather continuously overwritten in order to depict the current view from the optical hardware. Additionally, while in preview mode a delay can exist due to, for example, hardware and software constraints. As such, a display of the current view of camera module 37 can be a display of the view from camera module 37 at a time in past that can be described by the current time minus the delay.

As such, the camera module 37 can include all hardware, such as a lens or other optical component(s), and software necessary for creating a digital image file from a captured image, in the selective capture mode, or for displaying the current view of the camera module, in a preview mode. Camera module 37 may also include all hardware, such as a lens or other optical component(s), and software necessary to provide image zooming functionality. Image zooming functionality can include the ability to magnify or de-magnify an image prior to or subsequent to capturing an image. Image zooming functionality can be used in selective capture mode and preview mode.

In either selective capture mode or preview mode, camera module 37 can operate in conjunction with positioning sensor 37 and orientation module 39 to associate the location and orientation information of mobile terminal 10, at the moment of image capture. In some embodiments, a subset of the location and orientation information of mobile terminal 10, at the moment of image capture, can be utilized. Similarly, a zoom level, indicating the degree that camera module 36 is zoomed at the moment of image capture, can be associated with a digital image file. For example, in preview mode, in some embodiments, a set of location information, orientation information and zoom level can be associated with each captured image frame, or at some lesser interval in which a common set of information is associated with each image frame captured within the interval. In some embodiments, the zoom level can include information regarding the aspect ratio of a captured image.

Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processor or co-processor which assists the controller 20 in processing image data and an encoder and/or decoder for compressing and/or decompressing image data. The encoder and/or decoder may encode and/or decode according to, for example, a joint photographic experts group (JPEG) standard or other format.

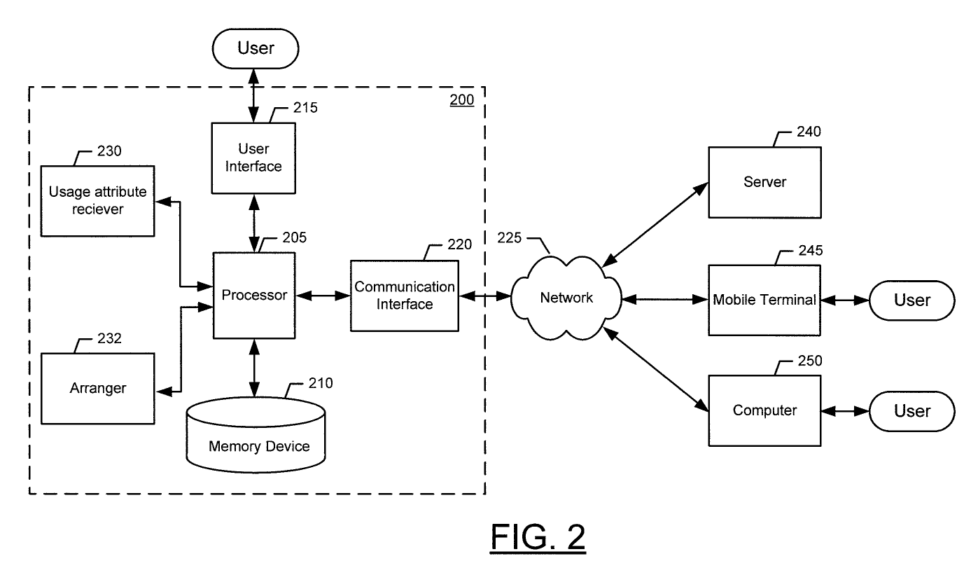

Referring now to FIG. 2, an apparatus 200 for enabling usage analysis is provided. Apparatus 200 may be embodied as a server or other network device including a mobile terminal, such as mobile terminal 10 of FIG. 1 and a computer, such as a personal computer. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be configured to store information, data, applications, instructions or the like for enabling the apparatus to carry out various functions in accordance with exemplary embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with usage attributes, objects, or the like.

The processor 205 may be embodied in a number of different ways. For example, the processor 205 may be embodied as a microprocessor, a coprocessor, a controller, or various other processing means or elements including integrated circuits such as, for example, an ASIC (application specific integrated circuit) or FPGA (field programmable gate array). In an exemplary embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical or other output to the user. As such, the user interface 215 may include, for example, a keyboard, a mouse, a joystick, a touch screen display, a conventional display, a microphone, a speaker, or other input/output mechanisms. In an exemplary embodiment in which the apparatus is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware and/or software for enabling communications with network 225, which may be any type of wired or wireless network. Via the communication interface 220 and the network 225, the apparatus 200 may communicate with the server 240, the mobile terminal 245, and/or the computer 250.

In this regard, the server 240 may be any type of computing device for storing, retrieving, computing, transmitting, and receiving data. In this regard, the server 240 may include a memory device, a processor, and a communication interface for communicating with the network 225. In some embodiments, the server 240 may be a web server, database server, file server, or the like. In some embodiments, the server 240 may store usage attributes associated with one or more, users in addition to one or more user's content (e.g., shared files, photos, etc.) and status information.

The mobile terminal 245 may also be any type of device for storing, retrieving, computing, transmitting and receiving data. In some embodiments, mobile terminal 245 may be embodied as a mobile terminal 10 of FIG. 1.

Similarly, the computer 250 may also be any type of computing device for storing, retrieving, computing, transmitting, and receiving data. In this regard, the computer 250 may include a memory device, a processor, user interface for presenting output to a user and receiving input from a user, and a communication interface for communicating with the network 225. In some embodiments, the computer 250 may be a personal computer capable of running applications including web-browsers, widgets, or other applications, which may or may not transmit and receive data to/from the network 225. Via the computer 250, a user may access an exemplary online service using a browser or a dedicated application.

In some embodiments, the system of FIG. 2 may be utilized for synchronization of data amongst the various network platforms. In this regard, the network platforms (i.e., the apparatus 200, the server 240, the mobile terminal 245, the computer 250, etc.) may be used by a user to access data. In some embodiments, the network platforms may be used to access data associated with an online service account. Any type of data may be synchronized amongst the platforms and made available for access. Types of data may include status information, content, user profile information, shared files (e.g., documents, photos, media content, etc.), usage attributes, or the like. Moreover, in some embodiments, data that may be synchronized may be objects as further described below. For example, a contacts list may be accessed and/or synchronized (i.e., updated) via the mobile terminal 245, the computer 250, the server 240, or the apparatus 200. Upon modifying the contacts list, the new information may be transmitted to a data storage device (e.g., the apparatus 200 or the server 240) or otherwise made available to the various network platforms for subsequent access.

In this manner, data modified on one platform may be available to another platform. For example, the modified contact information may be automatically transmitted from the mobile terminal 245 to the server 240 or the apparatus 200 for synchronization purposes. As such, the user may later access the modified contact information via computer 250 and/or a browser.

In some embodiments, a user may set synchronization parameters, which may identify types of data that should be synchronized and types of data that need not be synchronized. For example, a user may set the synchronization parameters to synchronize the contact list, but may also set the synchronization parameters such that user profile information need not be synchronized. In various embodiments, various usage attributes and/or objects (as described further below) may or may not be synchronized.

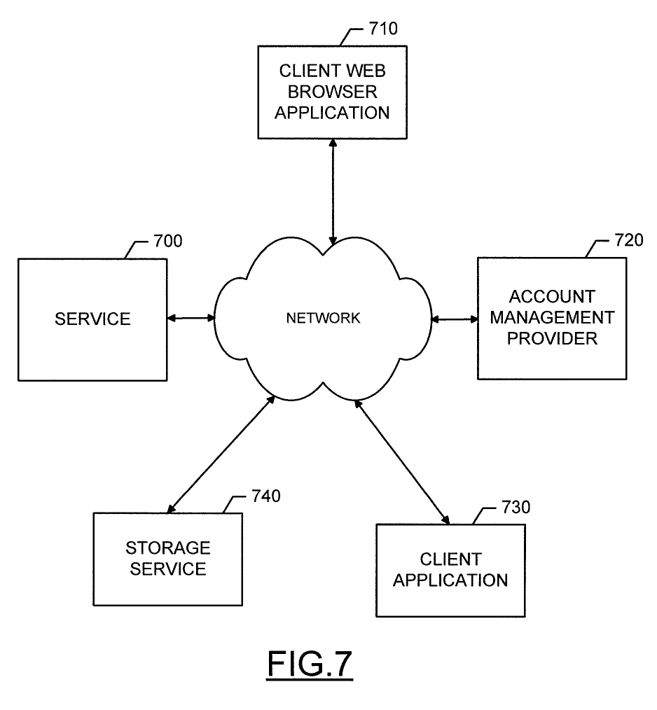

In this regard, and referring now to FIG. 7, an embodiment of a system in accordance with aspects of the present invention is illustrated. The system of FIG. 7 includes a service 700, a client web browser application 710, an account management provider 720, a client application 730, and a storage service 740. The service 700, the client web browser application 710, the account management provider 720, the client application 730, and the storage service 740 may be interconnected via the illustrated network, which may operate in the same manner as network 225.

The service 710, the account management provider 720, and the storage service 740 may collectively represent an embodiment of the apparatus 200 of FIG. 2. In this regard, the service 710 may represent an internet or network service (e.g., a website, a social networking website, a blog website, a web feed, a widget, or the like) that may receive and interact with usage attributes in a manner described with respect to the usage attribute receiver 230, the arranger 232, and the processor 205. Various types of data, such as, but not limited to, usage attributes, may be synchronized with and/or otherwise transferred to and from the service 700. The service 700 may utilize the storage service 740 for storage and retrieval of data by the service 700. In various embodiments, the storage service 740 may operate in the same manner as the memory device 210 and/or the server 240. Further, the account management provider 720 may operate together with the various other network entities to perform account management and security features. In some embodiments, login information and passwords are first directed to the account management provider 720 for verification. Upon verification, the account management provider 720 may provide access to, and allow communications between, various network entities using, for example, a token or other access key.

Client application 730 may be a software or hardware application residing and operating on a platform, such as a computer, mobile terminal, or the like, that may be used to interact with the service 700. In some embodiments, the client application 730 may reside and operate on the apparatus 200, the mobile terminal 245, the computer 250, or the like, and may operate in the same manner as apparatus 200, the mobile terminal 245, the computer 250, or the like. The client application may be downloaded to and/or installed on the platform. In some embodiments, the client application 730 may be specifically tailored to interact with the service 700. Via the client application 730, the platform, and the user of the platform, may interact with the service 700 to send and receive data, such as usage attributes, between the client application 730 and the service 700. The client application 730 may facilitate the gathering and storage of usage attributes for subsequent transmission to the service 700.

Similar to the client application 730, the client web browser application 710 may be a software or hardware application residing and operating on a platform, such as a computer, mobile terminal, or the like, that may be used to interact with the service 700. In this regard, the client web browser application 710 may be a generic network communication application for interacting with various network entities, including the service 700. In some embodiments, the client web browser application 710 may reside and operate on the apparatus 200, the mobile terminal 245, the computer 250, or the like, and may operate in the same manner as the apparatus 200, the mobile terminal 245, the computer 250, or the like. Via the client web browser application 710, the platform, and the user of the platform, may interact with the service 700 to send and receive, as well as synchronize, data, such as usage attributes, between the client web browser application 710 and the service 700. The client web browser application 710 may facilitate the gathering and storage of usage attributes for subsequent transmission to the service 700.

Referring back to FIG. 2, the usage attribute receiver 230 of apparatus 200 may be any means or device embodied in hardware, software, or a combination of hardware and software that is configured to carry out the functions of the usage attribute receiver 230 as described herein. In an exemplary embodiment, the processor 205 may include, or otherwise control the usage attribute receiver 230. In various exemplary embodiments, the usage attribute receiver 230 may reside on a server or other network device including a mobile terminal, such as mobile terminal 10 of FIG. 1.

The usage attribute receiver 230 may be configured to receive a plurality of usage attributes. Means for receiving the plurality of usage attributes may include the processor 205, the usage attribute receiver 230, a receiver, algorithms for receiving the plurality of usage attributes described herein and/or the like. The usage attribute receiver 230 or the processor 205 may be configured to store the plurality of usage attributes on the memory device 210. The plurality of usage attributes may have associations with a plurality of objects, such that each usage attribute within the plurality of usage attributes may be indicative of an action taken by a user with respect to at least one object within the plurality of objects. In some embodiments, user attributes may be associated with and received based on synchronization parameters. For example, synchronization parameters may be set such that only the synchronized usage attributes may be received.

In this regard, in some embodiments, an object may be a contact within a contact list, and usage attributes indicative of actions taken with respect to a contact may be data describing when or how frequently the contact is called, emailed, text messaged (i.e., sent a message via a short message service (SMS), or the like. Usage attributes with respect to a contact may also include the duration of calls to a contact, when or how frequently a contact initiates a call, where a user is located when calls are placed (via, for example, the positioning sensor 36 of mobile terminal 10), what data or content has been shared with the contact, and the like. In various embodiments, objects that are contacts may be generated on a platform such as a mobile terminal or computer.

In some embodiments, an object may be a media content item, such as a music track, a photo, or a video stream. The media item may be downloaded from another location or generated via a platform associated with the user, by implementing, for example, camera module 37 of mobile terminal 10. Usage attributes indicative of actions taken with respect to a media content items may be data describing when or how frequently the media content item is played, when playback of the media content item is stopped, when or how often a media content item is downloaded, where the user is located when the media content item is played, the entities that have shared the content with the user, or the like.

In some embodiments, an object may be an application, such as a game. Usage attributes indicative of actions taken with respect to an application may be data describing when or how frequently the application is executed, how long the application is used, who is also executing a common instance of the application (e.g., who else was playing the game), where the user is located when the application is executed, or the like.

Various other types of objects are also contemplated, such as websites, events, calendar entries, and the like. Various associated usage attributes, such as the usage attributes described above, may also be considered with respect to these and other objects.

Usage attribute receiver 230 may receive the usage attributes from a plurality of platforms. A platform may be an electronic device, such as a mobile terminal (e.g., mobile terminal 245), an online service, such as that provided by a server (e.g., server 240), a network (e.g., network 225) and/or entities on the network, or the like. In this regard, usage attributes may be captured by the various platforms and the platforms may provide the usage attributes to the usage attribute receiver 230. For example, usage attributes associated with a phone call made by a user to the subject of a contact entry, i.e., the object, may be captured by the mobile terminal used to make the call. The usage attributes associated with the contact may be provided by the mobile terminal (i.e., the platform) to be received by the usage attribute receiver 230.

In this regard, each platform may be associated with the user. A user may be an individual, a login identity for an online account, or any other entity depending, at least in part, on the type of platform. For example, if a platform is a mobile terminal, the user may use or own the mobile terminal. If the platform is an online service, the user may have an account with the online service. Further, if the platform is a computer, the user may use or own the computer. In the same regard, if the platform is a network, the user may have an account with the network.

In addition to receiving the usage attributes, usage attribute receiver 230 may also receive objects, or representations of the objects, from one or more platforms. Platforms that may provide the objects may include mobile terminals, (e.g., the mobile terminal 245), servers (e.g., server 240), online services associated with the server, computers (e.g., computer 250), or the like.

The arranger 232 of apparatus 200 may be any means or device embodied in hardware, software, or a combination of hardware and software that is configured to carry out the functions of the arranger 232 as described herein. In an exemplary embodiment, the processor 205 may include, or otherwise control the arranger 232. In various exemplary embodiments, the arranger 232 may be embodied at a server or other network device including a mobile terminal, such as mobile terminal 10 of FIG. 1.

Arranger 232 can be configured to arrange indications of the objects within the plurality of objects based on the plurality of usage attributes. Means for arranging indications of the objects within the plurality of objects based on the plurality of usage attributes may include the processor 205, the arranger 232, algorithms for arranging indications of the objects within the plurality of objects based on the plurality of usage attributes described herein and/or the like. According to various embodiments, the arrangement of indications of objects may be presented to a user in various formats. The arrangements may be presented via various devices (i.e., platforms) including, for example, the user interface 215, the mobile terminal 245, or the computer 250. In this regard, indications of objects may be textual indications (e.g., titles, names, etc.), graphical indications (e.g., icons, images, etc.), or the like. These indications of the objects can be arranged based on the usage attributes in various manners for presentation. In some embodiments, the usage attributes associated with an object may be aggregated to determine an aggregated value with respect to the object. Aggregated values may be a value indicating the number of total calls made to a contact, or a total number of times a media item has been played or viewed, or the like. In this regard, for example, indications of objects may be listed in order from highest to lowest, where the first (or highest) indication of an object is associated with aggregated usage attributes having a highest aggregated value for the associated object and conversely the last or lowest indication of an object is associated with aggregated usage attributes having a lowest aggregated value for the associated object. Similarly, in some embodiments, rather than a list, indications of objects may be arranged graphically. In this regard, indications of objects may be associated with a shape (e.g., circle, square, triangle, etc.), and the size of the shape may indicate an aspect of the usage attributes with respect to the object. For example, in an exemplary arrangement bigger sized shapes may be associated with objects associated with a higher aggregated usage attribute values, and smaller sized shapes may be associated with objects associated with a lower aggregated usage attribute values. Further, other graphs such as line graphs, bar graphs, or the like may be the basis for arranging the indications of the objects.

In some embodiments, some objects having usage attributes or aggregated usage attributes that do not meet minimum criteria may be excluded from the arrangement. Example criteria may include various thresholds depending on the object and its associated usage attribute, such as a threshold number of calls to contact, a threshold duration associated with playing a media content item, etc. Further, some criteria may be determined based on the usage attributes of various other related objects. For example, in some embodiments, indications of objects may be arranged based on percentages (e.g., contact A received 33% of all calls made by the user). In this regard, a minimum percent threshold may be defined where the percentages are determined based on an aggregation of all usage attributes of a particular type (e.g., phone calls initiated) with respect to a type of object (e.g., contacts). For example, a threshold may be defined that only contacts associated with at least 5% or more of the total calls will be included in the arrangement. Further, in embodiments where the size of an indication of an object changes with respect to the usage attributes, space limitations of a display may be considered as criteria when arranging indications of objects. For example, a minimum percentage threshold may be increased because only a predefined number of shapes may fit on an exemplary display screen or in an exemplary frame on a webpage. Additionally, the platform that is presenting the arrangement may be considered as criteria when arranging indications of objects. For example, if the arrangement is displayed on a mobile terminal, such as mobile terminal 10, the arrangement may be a textual list. However, the arrangement may be presented as a graphical representation if the information is accessed via a browser, widget, or other client application on a personal computer. Further, the arrangements may be incorporated into a presentation that includes other information to generate a dashboard-type display. In this regard, the arrangement may be displayed in frames or widgets within the larger display to provide a user with an aggregated view of various arrangements of indications of various types of objects.

Further, in some embodiments, the arrangement of objects and associated usage attributes by the arranger 232 may be depicted in various manners based on the context in which the objects and associated usage attributes are being presented. The arrangement of a set of objects in a list may vary based on the context of the webpage presenting the objects. In this regard, a “music” webpage may include an arrangement of objects of a contact list that are most often listening to music, most often listening to similar music, or the like. On a corresponding webpage directed to communications, the same objects in a contact list may be arranged based on, for example, the frequency of communications received from the contacts.

Further, in some embodiments, the arrangement of the objects may be based on the arrangement of objects associated with other entities, such as entities within a user's contact list. Moreover, in some embodiments, when a user logs on to an online account, the arrangement of the objects within the initial presentation of objects may be based on the presentations and arrangements of objects for the other entities. For example, user 1 may have user 2 in her contacts list, and user 2 may be a top contact within user 1's contacts list based on, for example, the frequency of telephone calls made between user 1 and user 2. The behavior of user 2 may be determined based on usage attributes associated with user 2 and objects associated with user 2 may be arranged in accordance with the usage attributes of user 2. Accordingly, the arrangement of objects for user 1 may be based on user 2's arrangement, since it may be assumed that user 1 and user 2 appear to have similar interests.

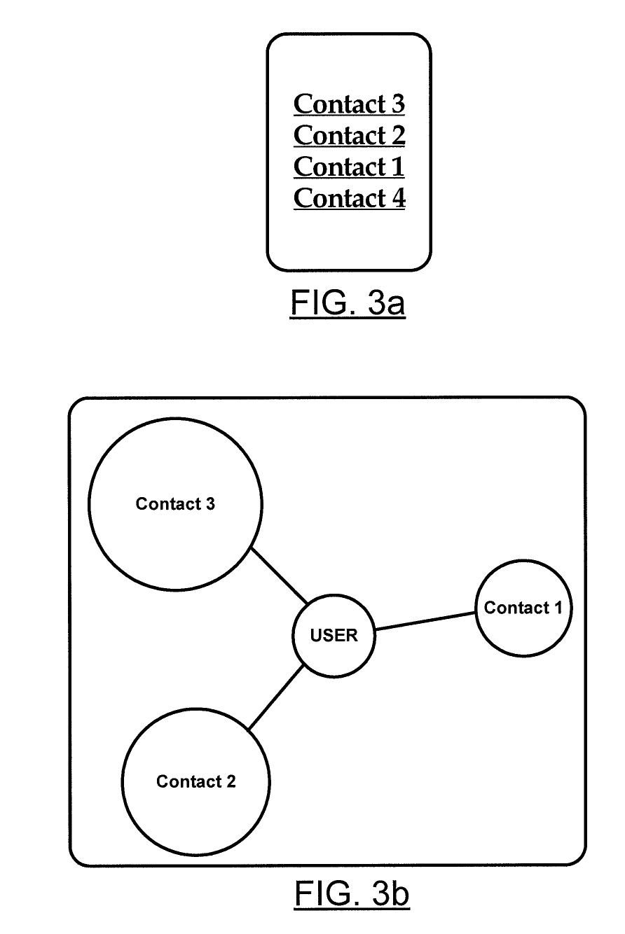

Exemplary arrangements of indications of objects will now be described with reference to FIGS. 3a and 3b. The exemplary arrangements of FIGS. 3a and 3b are based on usage attributes describing numbers of phone calls made to objects that are contacts within a user's contact list. In this regard, contact 1 is associated with usage attributes indicating that 10 phone calls were placed by the user to contact 1. Contact 2 is associated with usage attributes indicating that 20 phone calls were placed by the user to contact 2. Contact 3 is associated with usage attributes indicating that 30 phone calls were placed by the user to contact 3, and contact 4 is associated with usage attributes indicating that 2 phone calls were placed by the user the contact 4.

FIG. 3a illustrates an exemplary arrangement of indications of objects in accordance with various embodiments of the present invention. The exemplary arrangement of FIG. 3a is a list of textual indications of contact objects. The exemplary arrangement of FIG. 3a may be presented in a frame or widget of a larger display, such as a website. Titles associated with the objects are listed in order based on the usage attributes associated with the contacts. In the exemplary embodiment of FIG. 3a, the contact titles are arranged such that the title of the contact with the highest number of associated phone calls is listed first (i.e., contact 3 with 30 calls), the title of the contact with the second highest number of associated phone calls is listed second (i.e., contact 2 with 20 calls), and so on. In this example, if a minimum threshold had been defined to be 5 calls, contact 4 would not have been listed.

FIG. 3b illustrates another exemplary arrangement of indications of objects in accordance with various embodiments of the present invention. The exemplary arrangement of FIG. 3b is a graphical illustration of indications of contact objects where the size of the graphical indications of contacts (i.e., the circles) is based on the usage attributes associated with the contacts. Titles associated with the contacts may be located within circles (or any other shape) and the relative size of each circle may be indicative of which contact is associated with more or less calls. For example, since contact 3 is associated with 30 calls and contact 2 is associated with 20 calls, the circle for contact 3 is relatively larger than the circle for contact 2. Accordingly, the circle associated with contact 1 is relatively smaller than the others because contact 1 is associated with 10 calls. In this regard, based on the aggregated usage attributes for each contact, the circle associated with contact 3 may be 50% larger that the circle associated with contact 2, and the circle associated with contact 2 may be 50% larger than the circle associated with contact 1. The exemplary arrangement of FIG. 3b may include criteria that exclude contacts with less than a predetermined threshold of calls. In the exemplary arrangement of FIG. 3b, a threshold number of calls may be set to 5 and since contact 4 is associated with only 2 phone calls, contact 4 is excluded from the exemplary arrangement.

In various exemplary embodiments, usage attribute receiver 230 may also be configured to receive a second plurality of usage attributes. The second plurality of usage attributes may have associations with a second plurality of objects such that each usage attribute within the second plurality of usage attributes may be indicative of an action taken by a second user with respect to at least one object within the second plurality of objects.

In this regard, usage attributes describing actions taken by the second user may be received, which describe actions taken by the second user with respect to various objects. For example, usage attributes describing how often the second user plays an object that is a particular music track may be received.

In some embodiments, usage attributes may be received based on security attributes. In this regard, a user may define security attributes where the security attributes identify a set of entities that may receive a user's usage attributes and/or other information associated with a user. In some embodiments, the security attributes may allow reception of the usage attributes, but the security attributes may prevent the usage attributes from being included in an arrangement of objects. Security attributes may also be defined based on usage attributes. For example, a user may define security attributes that allow entities that often listen to similar music to receive or other wise have access to a user's usage attributes. In this same regard, an entity that does not listen to the same music may not have access to the user's usage attributes due to the defining of appropriate security attributes.

Further, in some embodiments, security attributes may be defined by a user's contact list. Further, in some embodiments, the security attributes may provide access to usage attributes to the entities identified in a contacts list. For example, user 1 may have user 2 in his contact list which may allow user 2 access to user 1's usage attributes. In this example, User 1 does not have user 3 in his contacts list. However, user 2 may have user 3 in his contact's list, and, as such, based on the security attributes, user 3 may have access to user 1's usage attributes by being in the contacts list of User 2 (i.e., a friend of a friend situation).

Further, in some embodiments the second plurality of usage attributes may be received from a given platform, where the given platform may be one of the plurality of platforms associated with the first user or another platform. In some embodiments, the given platform, from which the second plurality of usage attributes may be received, may be a mobile terminal, (e.g., the mobile terminal 245), a server (e.g., server 240), an online service associated with the server, a computer (e.g., computer 250), or the like.

In some embodiments, the usage attribute receiver 230 may be configured to select the second user based upon the received plurality of usage attributes associated with the first user. Means for selecting the second user based upon the received plurality of usage attributes associated with the first user may include the processor 205, the usage attribute receiver 230, the arranger 232, algorithms for selecting the second user based upon the received plurality of usage attributes associated with the first user described herein and/or the like. Further, in some embodiments, usage attribute receiver 230 may be configured to receive an update to the first plurality of usage attributes and select the second user based on the update to the first plurality of usage attributes. In this regard, the usage attribute receiver 230 may receive a first plurality of usage attributes, or updates, associated with a first user, and based on the received first plurality of usage attributes, or updates, usage attribute receiver 230 may select a second user. A second plurality of usage attributes associated with the second user may then be received based on the selection.

Various exemplary manners of selecting the second user may be implemented. For example, the usage attribute receiver 230 may receive a selection of a second user from an arrangement of indications of objects associated with the first user by clicking on, or otherwise selecting an indication of an object from the arrangement. In this regard, selecting the indication of the object may cause a user that is associated with a contact to be selected as the second user. Further, selecting the indication of the object may cause a user that most frequently listens to music track associated with the indication of the object to be selected. In this regard, in some embodiments, the first plurality of usage attributes may be compared with usage attributes of other user and a second user may be selected based on similarities between usage attributes. For example, comparisons of the usage attributes may indicate that the user listen to the same songs, call the same people, play the same games, etc. Based on the similarities, a second user may be selected. In any event, the usage attribute receiver 230 may include predefined rules defining how the second user is selected based on the usage attributes associated with the first user including, for example, in response to selection of an object.

Arranger 232 can be configured to arrange indications of the objects within the second plurality of objects based on the second plurality of usage attributes for presentation. In this regard, the indications of the object within the second plurality of objects may be arranged in the same manner as the indications of objects within the first plurality of objects as described above. In this regard, the exemplary arrangements of FIGS. 3a and 3b are equally applicable to arranging indication of objects within the second plurality of objects. In some embodiments, arrangements of indications of the first plurality of objects and arrangements of indications of the second plurality of objects may be presented simultaneously to allow comparisons between the arrangements.

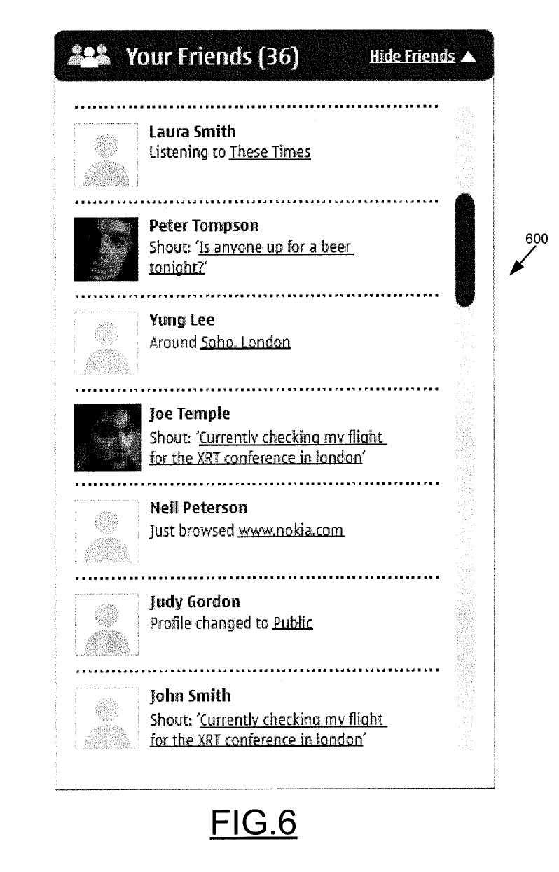

FIG. 6 depicts another exemplary arrangement of indications of objects 600 in accordance with various embodiments of the present invention where the objects are entities of a contact list and are ordered according to usage attributes. Again, the contacts within the list may be arranged as described above based on, for example, usage attributes associated with entities within a user's contact list and those entities' usage attributes. For example, the list of FIG. 6 may be arranged based on the usage attributes describing the types of music played by the entities of a contact list.

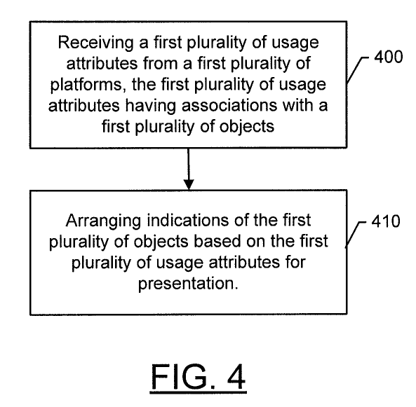

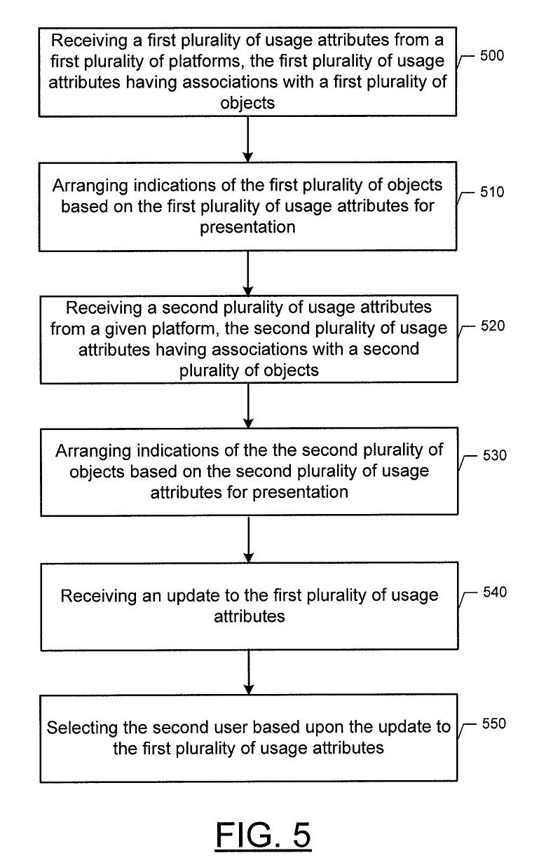

FIGS. 4 and 5 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one exemplary embodiment of a method for usage analysis as provided in FIG. 4 may include receiving a first plurality of usage attributes from a first plurality of platforms at operation 400. The first plurality of usage attributes may have associations with a first plurality of objects, where each usage attribute within the first plurality of usage attributes may be indicative of an action taken by the first user with respect to at least one object within the first plurality of objects. The first plurality of objects may include contacts associated with the first user or media content. Further, the first plurality of platforms may be associated with a first user. In some embodiments, the first plurality of platforms may include a mobile terminal and an online service.

The exemplary embodiment of a method for usage analysis as provided in FIG. 4 may also include arranging indications of the objects within the first plurality of objects at operation 410. In this regard, the indications of the first plurality of objects may be arranged based on the first plurality of usage attributes. Further, the indications of the objects may be arranged for presentation, for example, to a user.

Another exemplary embodiment of a method for usage analysis as provided in FIG. 5 may include receiving a first plurality of usage attributes from a first plurality of platforms at operation 500. In this regard, the first plurality of usage attributes may have associations with a first plurality of objects, where each usage attribute within the first plurality of usage attributes is indicative of an action taken by the first user with respect to at least one of the first plurality of objects. The first plurality of objects may include contacts associated with the first user or media content. Further, the first plurality of platforms may be associated with a first user. In some embodiments, the first plurality of platforms may include a mobile terminal and an online service.

The exemplary embodiment as provided in FIG. 5 may also include arranging indications of the objects within the first plurality of objects at operation 510. In this regard, the indications of the first plurality of objects may be arranged based on the first plurality of usage attributes. Further, the indications of the objects may be arranged for presentation, for example, to a user.

In an exemplary embodiment, the method may also include additional optional operations. In such embodiments, a second plurality of usage attributes may be received from a given platform at operation 520. In this regard, the given platform may be one of the first plurality of platforms or another platform. The second plurality of usage attributes may have associations with a second plurality of objects, and each usage attribute within the second plurality of usage attributes may be indicative of an action taken by the second user with respect to one of the second plurality of objects. In some embodiments, the given platform may be associated with a second user and/or the given platform may be a mobile terminal associated with the second user.

In some embodiments, receiving the second plurality of usage attributes may further comprise selecting the second user based upon the first plurality of usage attributes. Further, some embodiments may include receiving an update to the first plurality of usage attributes at operation 540, and selecting the second user based upon the update to the first plurality of usage attributes at 550.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a first plurality of usage attributes from a first plurality of platforms, the first plurality of platforms being associated with a first user, and each of the first plurality of usage attributes being associated with and indicative of an action taken by the first user with respect to at least one of a first plurality of objects; and
arranging indications of the first plurality of objects based on the first plurality of usage attributes for presentation.

2. The method of claim 1, wherein receiving the first plurality of usage attributes comprises receiving the first plurality of usage attributes from the first plurality of platforms, the first plurality of platforms including a mobile terminal and an online service.

3. The method of claim 1 further comprising:
receiving a second plurality of usage attributes from a given platform, the second plurality of usage attributes having associations with a second plurality of objects, and each of the second plurality of usage attributes being associated with and indicative of an action taken by the second user with respect to at least one of a second plurality of objects; and
arranging indications of the second plurality of objects based on the second plurality of usage attributes for presentation.

4. The method of claim 3, wherein receiving the second plurality of usage attributes comprises receiving the second plurality of usage attributes from the given platform, the given platform being a mobile terminal.

5. The method of claim 3, wherein receiving the second plurality of usage attributes further comprises selecting the second user based upon the first plurality of usage attributes.

6. The method of claim 3 further comprising:
receiving an update to the first plurality of usage attributes; and
selecting the second user based upon the update to the first plurality of usage attributes.

7. The method of claim 1 wherein receiving the first plurality of usage attributes comprises receiving the first plurality of usage attributes associated with the first plurality of objects, the first plurality of objects including contacts associated with the first user.

8. The method of claim 1 wherein receiving the first plurality of usage attributes comprises receiving the first plurality of usage attributes associated with the first plurality of objects, the first plurality of objects including media content.

9. A computer program product comprising at least one computer-readable storage medium having computer-readable program code portions stored therein, the computer-readable program code portions comprising:
a first executable portion configured to receive a first plurality of usage attributes from a first plurality of platforms, the first plurality of platforms being associated with a first user, and each of the first plurality of usage attributes being associated with and indicative of an action taken by the first user with respect to at least one of a first plurality of objects; and
a second executable portion configured to arrange indications of the first plurality of objects based on the first plurality of usage attributes for presentation.

10. The computer program product of claim 9, wherein the first executable portion being configured to receive the first plurality of usage attributes includes being configured to receive the first plurality of usage attributes from the first plurality of platforms, the first plurality of platforms including a mobile terminal and an online service.

11. The computer program product of claim 9, wherein the computer-readable program code portions further comprise:
a third executable portion configured to receive a second plurality of usage attributes from a given platform, and each of the second plurality of usage attributes being associated with and indicative of an action taken by the second user with respect to at least one of a second plurality of objects; and
a fourth executable portion configured to arrange indications of the second plurality of objects based on the second plurality of usage attributes for presentation.

12. The computer program product of claim 11, wherein the third executable portion being configured to receive the second plurality of usage attributes includes being configured to receive the second plurality of usage attributes from the given platform, the given platform being a mobile terminal.

13. The computer program product of claim 11, wherein the third executable portion being configured to receive the second plurality of usage attributes includes being configured to select the second user based upon the first plurality of usage attributes.

14. The computer program product of claim 11, wherein the computer-readable program code portions further comprise:
a fifth executable portion configured to receive an update to the first plurality of usage attributes; and
a sixth executable portion configured to select the second user based upon the update to the first plurality of usage attributes.

15. The computer program product of claim 9, wherein the first executable portion being configured to receive the first plurality of usage attributes includes being configured to receive the first plurality of usage attributes associated with the first plurality of objects, the first plurality of objects including contacts associated with the first user.

16. The computer program product of claim 9, wherein the first executable portion being configured to receive the first plurality of usage attributes includes being configured to receive the first plurality of usage attributes associated with the first plurality of objects, the first plurality of objects including media content.

17. An apparatus comprising a processor, the processor configured to:
receive a first plurality of usage attributes from a first plurality of platforms, the first plurality of platforms being associated with a first user, and each of the first plurality of usage attributes being associated with and indicative of an action taken by the first user with respect to at least one of a first plurality of objects; and
arrange indications of the first plurality of objects based on the first plurality of usage attributes for presentation.

18. The apparatus of claim 17, wherein the processor being configured receive the first plurality of usage attributes includes being configured to receive the first plurality of usage attributes from the first plurality of platforms, the first plurality of platforms including a mobile terminal and an online service.

19. The apparatus of claim 17, wherein the processor is further configured to:
receive a second plurality of usage attributes from a given platform, and each of the second plurality of usage attributes being associated with and indicative of an action taken by the second user with respect to at least one of a second plurality of objects; and
arrange indications of the second plurality of objects based on the second plurality of usage attributes for presentation.

20. The apparatus of claim 19, wherein the processor being configured to receive the second plurality of usage attributes includes being configured to receive the second plurality of usage attributes from the given platform, the given platform being a mobile terminal.

21. The apparatus of claim 19, wherein the processor being configured to receive the second plurality of usage attributes includes being configured to select the second user based upon the first plurality of usage attributes.

22. The apparatus of claim 19, wherein the processor is further configured to:
receive an update to the first plurality of usage attributes; and
select the second user based upon the update to the first plurality of usage attributes.

23. The apparatus of claim 17, wherein the processor being configured to receive the first plurality of usage attributes includes being configured to receive the first plurality of usage attributes associated with the first plurality of objects, the first plurality of objects including contacts associated with the first user.

24. The apparatus of claim 17, wherein the processor being configured to receive the first plurality of usage attributes includes being configured to receive the first plurality of usage attributes associated with the first plurality of objects, the first plurality of objects including media content.

25. The apparatus of claim 17 further comprising a memory device, and wherein the processor is further configured to store the first plurality of usage attributes in the memory device.

26. An apparatus comprising:
means for receiving a first plurality of usage attributes from a first plurality of platforms, the first plurality of platforms being associated with a first user, and each of the first plurality of usage attributes being associated with and indicative of an action taken by the first user with respect to at least one of a first plurality of objects; and
means for arranging indications of the first plurality of objects based on the first plurality of usage attributes for presentation.

27. The apparatus of claim 26 further comprising:
means for receiving a second plurality of usage attributes from a given platform, and each of the second plurality of usage attributes being indicative of an action taken by the second user with respect to at least one of a second plurality of objects; and
means for arranging indications of the second plurality of objects based on the second plurality of usage attributes for presentation.
